(19) United States
(12) Patent Application Publication
(10) Pub. No.: US 2025/0100808 A1
(43) Pub. Date: Mar. 27, 2025

(54) Egg Belt Tensioning Apparatus

(71) Applicant: Tecno Poultry Equipment S.p.A, Villafranca Padovana (IT)

(72) Inventor: Luca Terrassan, Villafranca Padovana (IT)

(21) Appl. No.: 18/293,569

(22) PCT Filed: Jul. 20, 2022
(86) PCT No.: PCT/IB2022/056690

§ 371 Date: Jan. 30, 2024

(30) Foreign Application Priority Data
Aug. 24, 2021 (GB) 2112107.4

(51) Int. Cl. B65G 23/44; A01K 31/18

(52) U.S. Cl. CPC B65G 23/44; A01K 31/18; B65G 2201/0208

(57) ABSTRACT

An egg belt tensioning apparatus is disclosed comprising a housing, a set of first rollers (12) located in fixed positions in the housing, a set of take up roller assemblies (16) mounted for movement with respect to the housing, a set of winding ribbons (30), and a set of belt winding rollers (32) each supported from the housing. Each of the winding ribbons (30) is connected at a first end to one of the take up roller assemblies (16) and at a second end to one of the belt winding rollers (32). In use an egg conveying belt is threaded around the first and second rollers and tensioned by the take up roller assemblies (16). The use of the belt winding rollers (32) allows for tension to be maintained in the egg conveying belt in a variety of environmental conditions thereby reducing the amount of maintenance of the egg belt tensioning apparatus required by an operator.

### FIELD OF THE INVENTION

The present invention relates to an egg belt tensioning apparatus for use in laying cages and aviary systems for poultry and in particular to improvements in such an apparatus.

### BACKGROUND

It is known to provide egg collection belts of plastics material, conveniently belts of woven polypropylene, to transport eggs in laying cages and aviary systems for poultry away from the poultry to a collection apparatus.

Such egg collection belts run over a series of pulleys and a driven by a driving pulley such that an egg deposited onto the egg collection belt may be transported.

However, due to the environmental conditions the egg collection belts may either expand or contract by around 2 to 4%. This leads to a risk either of the egg collection belt slipping on the drive pulley or overtensioning of the egg collection belt. As such there is a risk that the egg belts may not function as intended, or become damaged requiring replacement. In each of these situations the collection of eggs is interrupted.

It is known to provide slack belt take-up assemblies. These monitor the tension in a egg collector belt and if the tension in the egg collection belt drops beyond a predetermined threshold or if the tension in the egg collection belt exceeds a predetermined threshold the egg collector will be caused to shut down. While this protects the egg collector belt from undesirable damage, it does not prevent interruption in egg collection. Further since such undesirable changes in the tension in the egg collector belt can occur 2 to 3 times each day, frequent operator intervention is required to reset the egg collector belt.

It will be understood that the change in length of an egg collector belt imposes a restriction on the length of such a belt. Beyond a certain length and expansion of the belt quickly causes loss of tension (and too short and contraction quickly causes overtensioning). Typically lengths between 3 and 4 m are possible. Importantly, since as a practical matter an egg collector belt is restricted in length, many egg collection belts are required in a single aviary system, each requiring operator intervention.

It is an advantage of the present invention that these problems are addressed.

### SUMMARY OF THE INVENTION

According to a first aspect of the present invention, an egg belt tensioning apparatus comprises a housing, a set of first rollers located in fixed positions in the housing, a set of take up roller assemblies mounted for movement with respect to the housing, a set of winding ribbons, and a set of belt winding rollers each supported from the housing by a support element, each of the winding ribbons being connected at a first end to one of the take up roller assemblies and at a second end to one of the belt winding rollers.

Preferably, each take up roller assembly further comprises first and second carrier side elements, a second roller, second roller axle and a spacer element. More preferably, the housing provides guide channels for the take up roller assemblies. Still more preferably, each of the first and second carrier side elements is located on an outer side of housing, and the second roller axle and spacer element extend through the guide channels.

Preferably, each of the guide channels extends horizontally along the housing

Preferably, the guide channels are aligned vertically with one another.

Preferably, the first rollers are aligned vertically in the housing with one another.

Preferably, each of the belt winding rollers includes a belt winding roller housing. More preferably, each of the support elements comprises first and second brackets. Still more preferably, the first bracket extends between a first side of the housing and a first side of the belt winding roller housing and the second bracket extends between a second side of the housing and a second side of the belt winding roller housing.

Preferably, each of the belt winding rollers are offset vertically from an adjacent belt winding roller.

### BRIEF DESCRIPTION OF THE DRAWINGS

The invention will now be described, by way of example only, with reference to the accompanying drawings, in which:

FIG. 1 shows a side view of an egg belt tensioning apparatus in accordance with the present invention;

FIG. 2 shows a view similar to FIG. 1, with a side panel removed for clarity;

FIG. 3 shows a first end of the egg belt tensioning apparatus shown in FIG. 2;

FIG. 4 shows a second end of the egg belt tensioning apparatus shown in FIG. 2; and

FIG. 5 shows a sectional view of a take up roller assembly in the egg belt tensioning apparatus shown in FIG. 2.

### DETAILED DESCRIPTION OF SPECIFIC EMBODIMENTS OF THE INVENTION

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

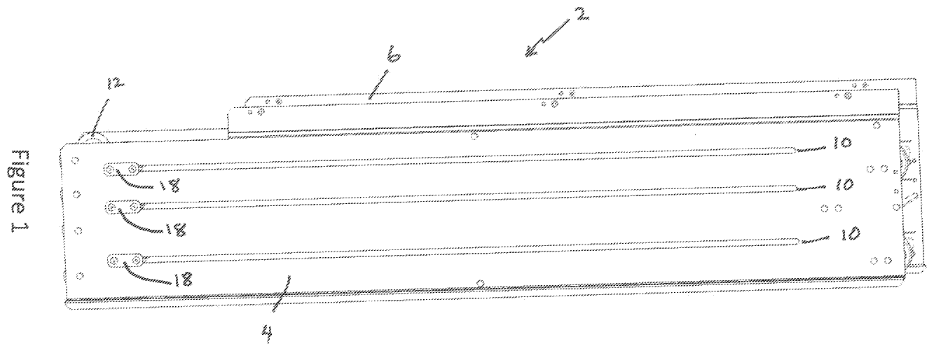

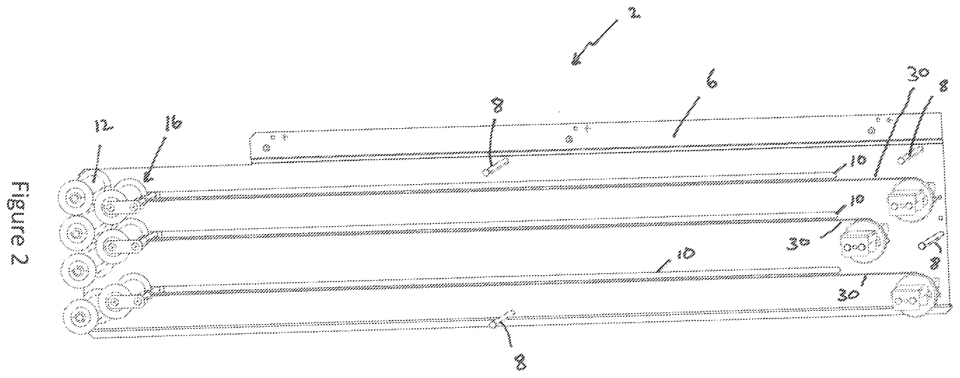

With reference first to FIGS. 1 and 2, an egg belt tensioning apparatus 2 is shown. A housing of the egg belt tensioning apparatus 2 comprises a front plate 4 and a rear plate 6 separated by a number of spacer elements 8. In the illustrated embodiment, four such spacer elements 8 are shown.

Each of the front plate 4 and the rear plate 6 are provided with a plurality of corresponding guide channels 10. In the illustrated embodiment three such side channels 10 are shown in each of the front plate 4 and the rear plate 6. Each of the guide channels 10 extend horizontally along the respective front or rear plate 4,6. In the illustrated embodiment, on each of the front plate 4 and the rear plate 6, the guide channels 10 are vertically aligned.

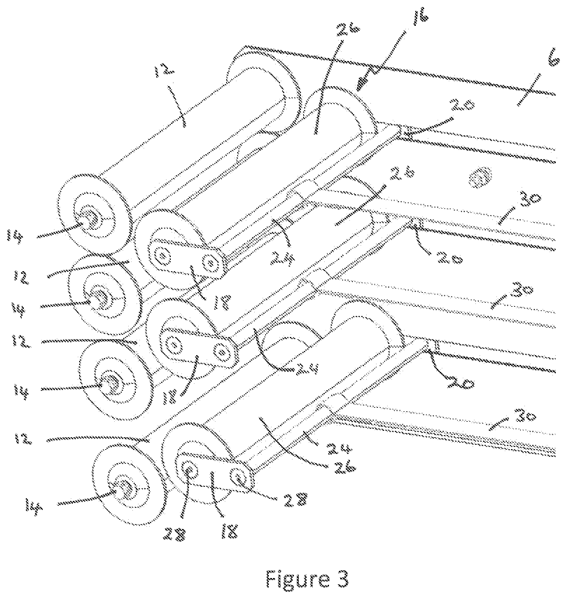

As can best be seen in FIG. 3, a set of first rollers 12 are located at a first end of the housing. The axles 14 about which these first rollers 12 are mounted for rotation are located in fixed positions with respect to the housing. In the illustrated embodiment, there are four such first rollers 12. In the illustrated embodiment, the first rollers 12 are vertically aligned with one another.

The fixed positions of the axles 14 of the first rollers 12 are offset vertically and horizontally from the guide channels 10.

A set of take up roller assemblies 16 can also be seen. In the illustrated embodiment there are three such take up roller assemblies 16. Each take up roller assembly 16 comprises front and rear carrier plates 18,20 and an axle 22 and a spacing connecting pin 24 mounted between the front and rear carrier plates 18,20. A second roller 26 is mounted for rotation about the axle 22 (FIG. 5). Each of the front and rear carrier plates 18,20 is connected to the axle 22 and to the spacing connecting pin 24 by a suitable fastener 28, for example a hex screw. The front and rear carrier plates 18,20 are, in use, located outside of the housing with the second roller 26 located between the front and rear plates 4,6 of the housing (FIG. 5). In this way, each take up roller assembly 16 is associated with a particular set of guide channels 10 in the housing.

A winding ribbon 30 is connected at a first end in any suitable manner to the spacing connecting pin 24. The winding ribbon 30 may be manufactured from any suitable material, for example of a polyester material.

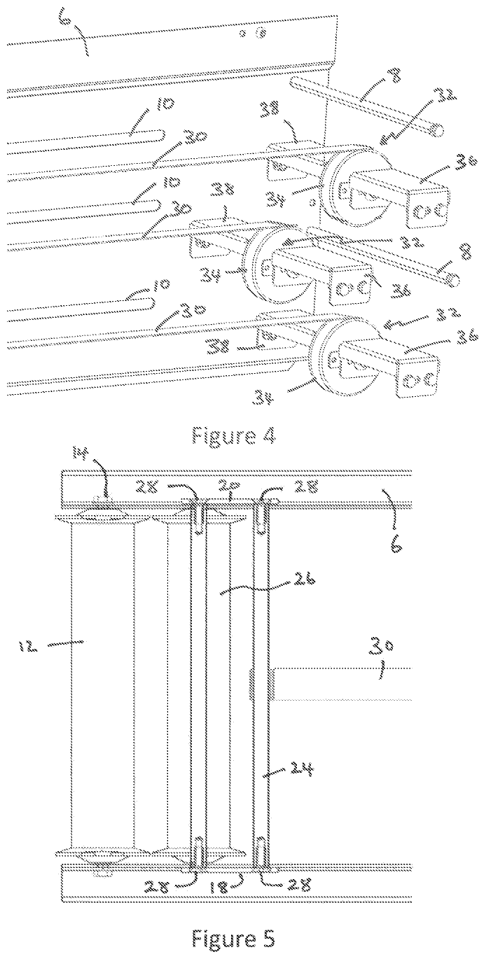

A second end of the egg belt tensioning apparatus is shown in FIG. 4. A set of belt winding rollers 32 can be seen. In the illustrated embodiment there are three belt winding rollers 32. In the illustrated embodiment each belt winding roller 32 is horizontally and vertically offset from an adjacent belt winding roller 32. In the illustrated embodiment each belt winding roller is offset horizontally and vertically from the neighbouring guide channel 10.

Each winding ribbon 30 is connected at a second end to one of the belt winding rollers 32.

Each belt winding roller 32 comprises a housing 34 including a pre-loaded spring (not shown) located within which, when released, causes the belt winding roller 32 to rotate about a central axis and consequently wind in the winding ribbon 30 connected to the belt winding roller 32. An example of a suitable belt winding roller 32 is the OMEGA brand pulley for a roller shutter sold by Stafer SpA.

Each belt winding roller housing 34 is supported by first and second brackets 36,38. The first bracket 36 extends between the front plate 4 and a first side of the belt winding roller housing 34 and the second bracket 38 extends between the rear plate 6 and a second side of the belt winding roller housing 34. Each of the first and second brackets 36,38 may be secured to the respective front and rear plates 4,6 and to the belt winding roller housing 34 by any suitable fastener.

An upper part of each belt winding roller housing 34 is vertically aligned with a neighbouring guide channel 10. It can be seen that each winding ribbon 30, extends substantially horizontally between the upper part of a belt winding roller housing 34 and the spacing connecting pin 24.

It will be seen that each of the belt winding rollers 32 can be used to draw a connected take up roller assembly 16 toward the second end of the egg belt tensioning apparatus 2. In use a suitable egg conveying belt (not shown) is threaded around the first and second rollers 12,26, such that the egg conveying belt follows a sinusoidal path within the egg belt tensioning apparatus 2. The belt winding rollers 32 are used to move each of the take up roller assemblies 16 (including the second rollers 26) away from the first rollers 12 to place the egg conveying belt in tension.

If the egg conveying belt of the illustrated embodiment expands due to environmental conditions, the tension in the springs of the belt winding rollers 32 takes up any slack generated in the egg conveying belt (as well as any slack caused by expansion of the winding ribbon 30). If the egg conveying belt contracts, the winding ribbon 30 is let out to maintain the desired tension in the egg conveying belt. In this way, a desired tension in the egg conveying belt is maintained in a variety of environmental conditions thereby reducing the amount of maintenance of the egg belt tensioning apparatus required by an operator.

Due to the use of the system described much longer egg conveying belts can be accommodated—up to 7 m in length.

From reading the present disclosure, other modifications will be apparent to persons skilled in the art. Such modifications may involve other features which are already known in the field of poultry cages and component parts therefore and which may be used instead of or in addition to features already described herein.

1. An egg belt tensioning apparatus comprising a housing, a set of first rollers located in fixed positions in the housing, a set of take up roller assemblies mounted for movement with respect to the housing, a set of winding ribbons, and a set of belt winding rollers each supported from the housing by a support element, each of the winding ribbons being connected at a first end to one of the take up roller assemblies and at a second end to one of the belt winding rollers.

2. An egg belt tensioning apparatus according to claim 1, characterised in that each take up roller assembly further comprises first and second carrier side elements, a second roller, second roller axle and a spacer element.

3. An egg belt tensioning apparatus according to claim 2, characterised in that the housing provides guide channels for the take up roller assemblies.

4. An egg belt tensioning apparatus according to claim 3, characterised in that each of the first and second carrier side elements is located on an outer side of housing, and the second roller axle and spacer element extend through the guide channels.

5. An egg belt tensioning apparatus according to claim 3, characterised in that each of the guide channels extends horizontally along the housing.

6. An egg belt tensioning apparatus according to claim 3, characterised in that the guide channels are aligned vertically with one another.

7. An egg belt tensioning apparatus according to claim 1, characterised in that the first rollers are aligned vertically in the housing with one another.

8. An egg belt tensioning apparatus according to claim 1, characterised in that each of the belt winding rollers includes a belt winding roller housing.

9. An egg belt tensioning apparatus according to claim 1, characterised in that each of the support elements comprises first and second brackets.

10. An egg belt tensioning apparatus according to claim 9, characterised in that the first bracket extends between a first side of the housing and a first side of the belt winding roller housing and the second bracket extends between a second side of the housing and a second side of the belt winding roller housing.

11. An egg belt tensioning apparatus according to claim 1, characterised in that each of the belt winding rollers are offset vertically from an adjacent belt winding roller.
